(19) United States
(12) Patent Application Publication
(10) Pub. No.: US 2005/0039588 A1
(43) Pub. Date: Feb. 24, 2005

(54) Two-shaft rotary safety cutter

(76) Inventor: Jou-Chen Chieng, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/644,820

(22) Filed: Aug. 21, 2003

(51) Int. Cl. B26D 1/14

(52) U.S. Cl. 83/485; 83/614; 83/478

(57) ABSTRACT

A two-shaft rotary safety cutter includes a worktable board set, a side guide set, a bracket set, a blade carriage set and a paper holder. The worktable board set is used for placing a paper to be cut, a fixed blade is connected to the top edge of the worktable board of the worktable board set, and two carriage sliding shafts of the bracket set are provided such that the blade carriage set is movably coupled to the bracket set. Furthermore, the blade penetrates through the blade accommodating slot of the paper holder and then slides along the cant edge of the fixed blade so as to cut the paper. The safety rim parallel with and protruded from the top edge of the worktable board provides a safety guard device for the cant edge of the fixed blade.

### BACKGROUND OF THE INVENTION

1. Field of the Invention

This invention relates to a two-shaft rotary safety cutter, and more particularly to a two-shaft rotary safety cutter having a safety rim protruded from the top edge of its worktable board.

2. Description of the Prior Art

A typical apparatus used in the office for cutting papers is called as a paper cutter. Such paper cutter is suitably used to cut a paper into a desired size.

The conventional rotary cutter comprises essentially of: a worktable board, a fixed blade, a side guide, a right bracket, a left bracket, a carriage sliding shaft, a carriage, a blade, a rubber element and a paper holder. The structure of such rotary cutter has the following disadvantages. For example, no safety guard device is provided on the cant edge of the fixed blade such that a person may get hurt when being in touch therewith. As is known in the prior art rotary cutter, since the cant edge of the fixed blade is connected to the top edge of the worktable board and has a sharp knife edge, the user may carelessly touch it and get hurt.

Accordingly, the above-described prior art product is not a perfect design and has still many disadvantages to be solved.

In views of the above-described disadvantages resulted from the conventional rotary safety cutter, the applicant keeps on carving unflaggingly to develop an improved two-shaft rotary safety cutter according to the present invention through wholehearted experience and research.

### SUMMARY OF THE INVENTION

An object of the invention is to provide a safety cutter, which comprises a paper holder with a safety rim.

Another object of the invention is to provide a two-shaft rotary safety cutter, in which the safety rim can be a spring or a bar parallel with the top edge of the worktable board so as to provide equivalent function of the safety rim.

The improved two-shaft rotary safety cutter that can accomplish the above-mentioned objects comprises essentially of:
a worktable board set, comprising a worktable board for placing a paper to be cut; a fixed blade connected to the top edge of the worktable board and having a cant edge; and four rubber feet disposed under the corners of the worktable board;
a side guide set, comprising a side guide fixed to one side of the worktable board; a depth guide having thereon a bolt hole for allowing the depth guide to be movably connected to the side guide; and a depth guide knob bolted in the bolt hole of the depth guide;
a bracket set, comprising a right bracket pivotally coupled to the right side of the worktable board; a left bracket pivotally coupled to the left side of the worktable board; and two carriage sliding shafts, wherein both shaft ends of the carriage sliding shafts are coupled to the corresponding apertures on the right bracket and the left bracket; and
a blade carriage set, comprising a carriage movably coupled to the carriage sliding shafts and sliding along the fixed blade at the top edge of the worktable board back and forth; a blade provided on the carriage and sliding along the fixed blade at the top edge of the worktable board as the carriage slides along the carriage sliding shafts; and a rubble element provided on the carriage, being concentric with the blade, and rolling on a paper holder as the carriage slides along the carriage sliding shafts;
wherein the paper holder is flat and provided with a strip-shaped safety rim, and is provided with a blade accommodating slot at an appropriate location above the fixed blade, wherein both sides of the paper holder is coupled to the bracket set, and the safety rim of the paper holder is parallel with and protruded from the top edge of the worktable board; wherein both sides of the paper holder is coupled to the right bracket and the left bracket of the bracket set, and the safety rim parallel with and protruded from the top edge of the worktable board provides a safety guard device for the cant edge of the fixed blade.

### BRIEF DESCRIPTION OF THE DRAWINGS

The drawings disclose an illustrative embodiment of the present invention which serves to exemplify the various advantages and objects hereof, and are as follows:

FIG. 1 is a three-dimensional exploded view of a two-shaft rotary safety cutter according to the present invention; and

FIG. 2 is a three-dimensional view of the two-shaft rotary safety cutter.

### DETAILED DESCRIPTION OF THE PREFERRED EMBODIMENT

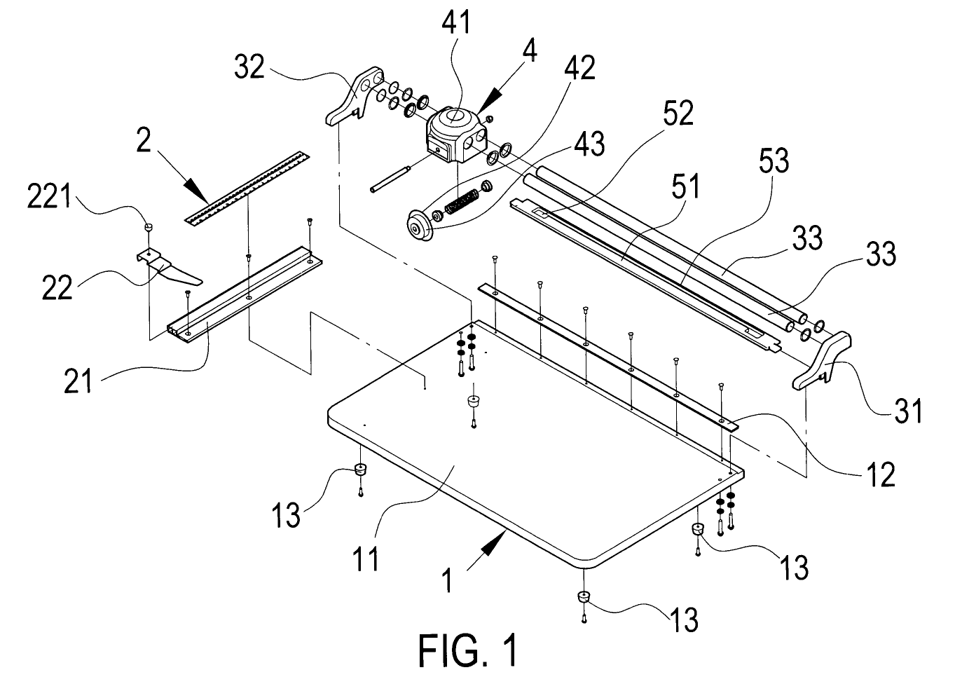

Referring to FIG.1, the two-shaft rotary safety cutter provided by the present invention comprises essentially of: a worktable board set 1, a side guide set 2, a bracket set 3, a blade carriage set 4 and a paper holder 51.

The worktable board set 1 comprises a worktable board 11 for placing a paper to be cut; a fixed blade 12 connected to the top edge of the worktable board 11 and having a cant edge; and four rubber feet 13 disposed under the corners of the worktable board 11.

The side guide set 2 comprises a side guide 21 fixed to one side of the worktable board 11; a depth guide 22 having thereon a bolt hole for allowing the depth guide 22 to be movably connected to the side guide 21; and a depth guide knob 221 bolted in the bolt hole of the depth guide 22.

The bracket set 3 comprises a right bracket 31 pivotally coupled to the right side of the worktable board 11; a left bracket 32 pivotally coupled to the left side of the worktable board 11; and two carriage sliding shafts 33, wherein both shaft ends of the carriage sliding shafts 33 are coupled to the corresponding apertures on the right bracket 31 and the left bracket 32.

The blade carriage set 4 comprises a carriage 41 movably coupled to the carriage sliding shafts 33 and sliding along the fixed blade 12 at the top edge of the worktable board 11 back and forth; a blade 42 provided on the carriage 41 and sliding along the fixed blade 12 at the top edge of the worktable board 11 as the carriage 41 slides along the carriage sliding shafts 33; and a rubble element 43 provided on the carriage 41, being concentric with the blade 42, and rolling on a paper holder 51 as the carriage 41 slides along the carriage sliding shafts 33.

The paper holder 51 is flat and provided with a strip-shaped safety rim 53, and is provided with a blade accommodating slot 52 at an appropriate location above the fixed blade 12, wherein both sides of the paper holder 51 is coupled to the bracket set, and the safety rim 53 of the paper holder 51 is parallel with and protruded from the top edge of the worktable board 11.

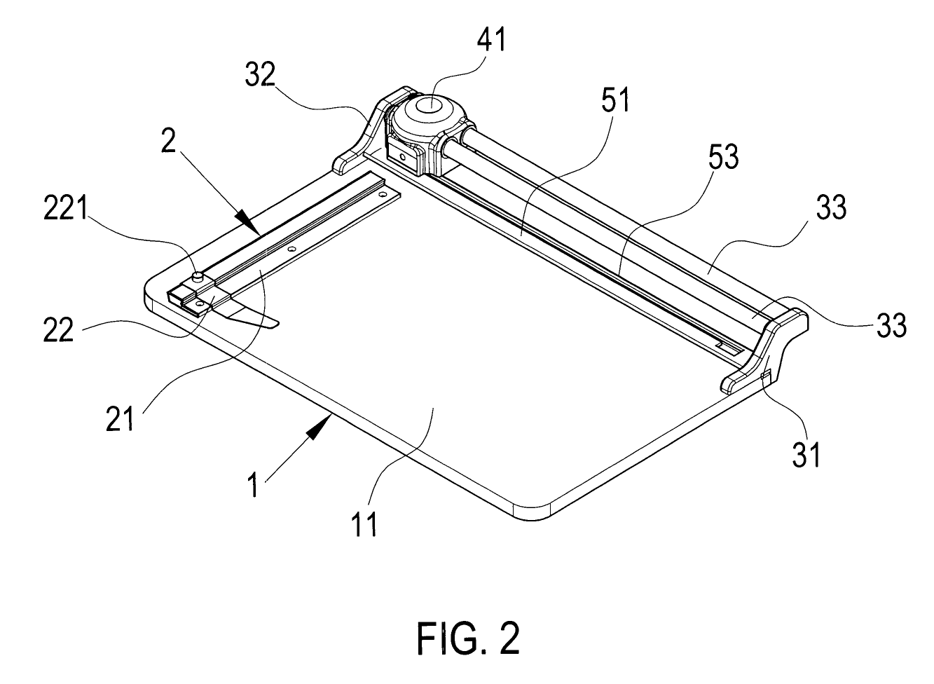

Please refer to FIG. 2. The worktable board set 1 is used for placing a paper to be cut, and a fixed blade 12 is connected to the top edge of the worktable board 11 of the worktable board set 1. Both sides of the worktable board 11 are coupled to the right bracket 31 and the left bracket 32 of the bracket set, and both shaft ends of the carriage sliding shafts 33 are coupled to the corresponding apertures on the right bracket 31 and the left bracket 32 such that the blade carriage set 4 is movably coupled to the bracket set. Furthermore, the blade 42 penetrates through the blade accommodating slot 52 and then slides along the cant edge of the fixed blade 12 so as to cut the paper. Both sides of the paper holder 51 is coupled to the right bracket 31 and the left bracket 32 of the bracket set, and the safety rim 53 parallel with and protruded from the top edge of the worktable board 11 provides a safety guard device for the cant edge of the fixed blade 12. Alternatively, both sides of the safety rim 53 on the paper holder 51 of the present invention can be integrally formed with the paper holder 51 onto the right bracket 31 and the left bracket 32 of the bracket set. Alternatively, the safety rim 53 can be a strip-shaped spring or a strip-shaped bar parallel with the top edge of the worktable board 11, and both sides of the spring or the bar is coupled to the right bracket 31 and the left bracket 32 of the bracket set so as to provide a safety guard device for the cant edge of the fixed blade 12.

The two-shaft rotary safety cutter of present invention, when comparing with other previous conventional technologies, has following advantages:

1. The two-shaft rotary safety cutter of present invention uses the paper holder to hold papers, and the safety rim thereof allows the hands of the user to indirectly touch the fixed blade at the top edge of the worktable board when the user takes the two-shaft rotary safety cutter, such that the safety rim forms a safety guard device.

2. Both sides of the safety rim on the paper holder can be integrally formed with the paper holder onto the right bracket and the left bracket of the bracket set.

3. The safety rim provided by the present invention can be a strip-shaped spring or a strip-shaped bar parallel with the top edge of the worktable board, and both sides of the spring or the bar is then coupled to the right bracket and the left bracket of the bracket set.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

1. A two-shaft rotary safety cutter, comprising essentially of:
a worktable board set, comprising a worktable board for placing a paper to be cut; a fixed blade connected to the top edge of said worktable board and having a cant edge; and four rubber feet disposed under the corners of said worktable board;
a side guide set, comprising a side guide fixed to one side of said worktable board; a depth guide having thereon a bolt hole for allowing said depth guide to be movably connected to said side guide; and a depth guide knob bolted in said bolt hole of said depth guide;
a bracket set, comprising a right bracket pivotally coupled to the right side of said worktable board; a left bracket pivotally coupled to the left side of said worktable board; and two carriage sliding shafts, wherein both shaft ends of said carriage sliding shafts are coupled to the corresponding apertures on said right bracket and said left bracket; and
a blade carriage set, comprising a carriage movably coupled to said carriage sliding shafts and sliding along said fixed blade at the top edge of said worktable board back and forth; a blade provided on said carriage and sliding along said fixed blade at the top edge of said worktable board as said carriage slides along said carriage sliding shafts; and a rubble element provided on said carriage, being concentric with said blade, and rolling on a paper holder as said carriage slides along the carriage sliding shafts;
wherein said paper holder is flat and provided with a strip-shaped safety rim, and is provided with a blade accommodating slot at an appropriate location above said fixed blade, wherein both sides of said paper holder is coupled to said bracket set, and said safety rim of said paper holder is parallel with and protruded from the top edge of said worktable board; wherein both sides of said paper holder is coupled to said right bracket and said left bracket of said bracket set, and said safety rim parallel with and protruded from the top edge of said worktable board provides a safety guard device for the cant edge of said fixed blade.

2. The two-shaft rotary safety cutter according to claim 1, wherein said safety rim is integrally formed with said paper holder onto said bracket set.

3. The two-shaft rotary safety cutter according to claim 1, wherein said safety rim is a spring.

4. The two-shaft rotary safety cutter according to claim 1, wherein said safety rim is a bar.
